(19) United States
(12) Patent Application Publication
(10) Pub. No.: US 2019/0116105 A1
(43) Pub. Date: Apr. 18, 2019

(54) SENSOR AND METHOD FOR THE SERIAL TRANSMISSION OF DATA OF THE SENSOR

(71) Applicant: ELESTA GmbH, Ostfildern (DE), Zweigniederlassung Bad Ragaz, Bad Ragaz (CH)

(72) Inventors: Roman Steiner, Ernetschwil (CH); Andreas Guntli, Walenstadt (CH); Raphael Möhr, Maienfeld (CH)

(21) Appl. No.: 16/164,686

(22) Filed: Oct. 18, 2018

(30) Foreign Application Priority Data
Oct. 18, 2017 (CH) 01275/17

(51) Int. Cl. H04L 12/26; H04L 29/08; G05B 9/02

(52) U.S. Cl. CPC H04L 43/08; G05B 9/02; H04L 67/12

(57) ABSTRACT

A method for the serial transmission of data from a sensor to a safety control device. The sensor has two data processing units which examine and process both the data of the sensor and the request data of the safety control device. The same request data of the safety control device are simultaneously supplied to each data processing unit and the data processing units simultaneously perform a check of the request data after receiving the data. The data processing units operate independently of each other. A sensor unit has a sensor, a safety control device and data processing units. The safety control device is connected to the data processing units via a common serial bus and the data processing units are independent of one another and simultaneously perform the data processing. A system for securing hazardous areas of production facilities with a sensor unit.

### CROSS-REFERENCE TO RELATED APPLICATION

This application claims priority to Swiss Patent Application No. 01275/17 filed Oct. 18, 2017, the entirety of which is incorporated by the reference.

The present invention refers to a method for the serial transmission of data of a sensor to a safety control device. The invention also refers to a sensor unit for performing the method and to a system having such a sensor unit.

Safety sensors usually monitor safety areas or secure them and provide information regarding the state of the safety area. For example, such safety sensors can be used on safety doors for machine tools or for industrial manufacturing equipment, in particular with robots. In such machines, a safety requirement is that no person may be in the working area of the machine during their operation. To this purpose, the area where, for example, an operator has to remain in order to set up, adjust or maintain the machine, has to be enclosed by protective walls and access occurs via said safety doors.

For example, safety sensors may be sensors which act as proximity sensors for the contactless detection of an approaching object. To this end, the use of so-called RFID (radio frequency identification) elements is known. These consist of a mostly passive RFID transmitter, also called an RFID tag, and an RFID receiver, which is often referred to as an RFID reader. When the RFID transmitter approaches the RFID receiver, the RFID transmitter is excited by an electromagnetic alternating field radiated from the RFID receiver and supplied with energy. The microcontroller of the RFID transmitter is then able to decode the commands sent by the RFID receiver and to set appropriate actions, such as the outputting of its stored information or the writing of new memory contents.

Safety doors are now secured, for example, by attaching an RFID transmitter to a first door element and an RFID receiver to a second door element. If the safety door is closed, the RFID transmitter is within range of the RFID receiver, RFID transmitter and RFID receiver are thus coupled and a command and information exchange is possible. If the safety door is opened, the RFID receiver can no longer detect or read the RFID transmitter and the RFID receiver can then transmit corresponding information to a safety control device and thus subsequently to a higher-level control device of a machine or other manufacturing device which prevents the machine from starting up and injuring a person who may be in the danger zone. Safety control devices can be formed from relatively simple safety relays to complex programmable logic controllers (PLCs).

For safety devices of this type, a safety integration level 3 (SIL3) in accordance with the IEC 61508 standard must be observed. These devices have to ensure a double safety, i.e. that an error occurring, for example, in the data transmission or during the data processing is insofar redundant in that this does not lead to any malfunction of the safety device. It is therefore known, for example, to read and process the data determined by the safety sensor in a first data processing unit and then to process the read data again in a second data processing unit or to check the processed data. As a result, these two data processing units compare their results and in particular forward safety-relevant information, such as the information “door is closed” (which may indicate to a higher-level control device that the machine may start up) to a safety control device or to a higher-level control device of a machine, if the results of the verification match and thus can be assumed that the data consistency is given. In general, the separate data processing units are constructed differently, for example by the use of different electronic components, yet both data processing units produce the same results when they are operating correctly.

Generally, safety sensors require that sensed data from the sensor be quickly forwarded to safety controllers or machine controllers to minimize risk time. Although the aforementioned two-stage and consecutive verification ensures secure reception and processing of the data, it understandably counteracts the goal of fast response times of the controllers.

Various standards have been established to allow communication between sensors or actuators and control and monitoring devices. One of them is the so-called IO-Link standard in accordance with IEC61131-9 or according to IO-Link System Description—Technology and Application, Version July 2013, Order number 4.392, which has been extended to be used in safety-related applications. This extension is known as IO-Link Safety Standard according to the IO-Link Safety System Extensions Specification, Version 1.0, April 2017, Order No: 10.092. Other well-known standards for safety-related applications include: the AS-i bus standard or the CANopen safety standard.

These safety standards ensure safe communication between sensors or actuators and control and monitoring devices. In relation to the present invention, this means that compliance with the IO-Link Safety Standard, for example, results in fail-safe communication between the safety control device and the sensor or between the safety control device and the data processing units of the sensor, even though the data is only sent over a single transmission path. The redundancy is therefore not given by the double execution of circuit arrangements or the like, but is ensured by compliance with the IO-Link Safety Standard.

The transmission path is therefore fail-safe, but it remains unclear how the safety-relevant data or their electrical signals have to be safely handled, i.e. input or output and stored and processed in a safety-relevant device so that the requirements of IEC61508 are (still) ensured. Incidentally, communication between the safety control device and a higher-level system takes place in a known manner through the use of known fieldbus systems.

DE 10 2007 019 846 describes a method and a device for monitoring a functional unit in a vehicle. The device comprises a data bus, an evaluation device with a first evaluation unit, a second evaluation unit, at least one sensor for detecting a measured value and a control device, each evaluation unit being connected to at least one sensor. Each evaluation unit receives data from at least one sensor and evaluates the data by means of calculation and plausibility check for results. The second evaluation unit is connected, for the output of results, via the data bus to the control device, and the first evaluation unit is also connected to the data bus, for reading the results. The first evaluation unit reads the result from the data bus and compares this with its own result. In the event of an error, the first evaluation unit prevents an output of further results on the data bus. Such a method makes it possible to dispense with expensive bidirectional communication steps between the evaluation units. The main advantage of the method described is thus the double use of the result output on the data bus for the purpose of informing the second evaluation unit and for informing the control device and thus omitting a complicated matching procedure between the evaluation units.

DE 10 2011 102 274 discloses a method for operating a safety controller which determines a floating-point value in response to an input signal. The determined floating-point value is forwarded via signal lines to two calculation units, each of which determines an input interval as a function of the floating-point value. The result intervals are forwarded to two independent comparison units, which receive the respective result interval of the other calculation unit via further lines. Within the comparison units, the result intervals are compared with each other. If the result intervals overlap, it is checked whether an output criterion is fulfilled. The output criterion is fulfilled if the result intervals contain a common value that corresponds to an opened safety door. The advantage of this method is that the floating-point value increases the accuracy of the safety control device when detecting the input signal as opposed to integer operations.

EP-A-2 339 415 discloses a control system for a construction machine with at least one sensor and at least a controller, there being a serial connection between the sensor and the controller. Sensor and controller have two or more channels. Within a sensor at least two transducers and at least two processing units are arranged in a mutually redundant and/or diversity way. In addition, at least two processing units of the sensor are coupled to one another via a data connection, wherein the processing units are operated synchronously. During operation, the measured values originating from the sensors are internally checked for correctness and then stored in a data packet of the measured value protocol, which is provided with safety information. For this purpose, the measured values are exchanged between the individual processing units and a plausibility check is carried out. If the deviations of the measured values lie within defined tolerance limits, the measurement is classified as plausible and the processing units involved agree on a measured value that applies to all the processing units. The controller also has two redundantly and/or diversely arranged control units, which are linked to each other via any bus system, so that a data exchange between them is possible.

According to one embodiment variant, a processing unit sends its signal via the bus and all further processing units listen to the transmission signal applied by the one processing unit to the bus and check this for correctness. For each channel of a sensor, an individual sensor description is also saved, which is stored by the manufacturer. This sensor description represents a unique and individual identification of each sensor used. On the basis of the sensor description, an individual key can be calculated for each sensor by means of a specified algorithm, which is transmitted as an addition during the transmission of the measured value from the sensor to the controller. From the measured value, a time stamp and a coded safety information, the measured value protocol generates a data packet, wherein the coded safety information is expediently calculated by means of the safety and/or protective function from the measured value, the time stamp and the individual key of the sensor. With the help of the safety and/or protection function, after evaluating the contents of the transmitted data packets, possible data manipulations or transmission errors can be detected on the receiver side and, with particular preference, corrected.

It is an advantage of the invention to provide a method for the serial transmission of data of the sensor from a safety control device to a sensor, so that requests can be safely input and output and safely stored and processed. Likewise, the invention provides a sensor unit and a system for safeguarding production facilities in such a way that requests are input and output safely and stored and processed safely. In this case, the reaction time or the response time of the sensor unit or of the system should be reduced to a minimum in order to minimize, for example, the risk time of the entire production facility to be considered in the design and planning.

The advantages are achieved by a method according to the invention that simultaneously supplies the same data and simultaneously checks the received data by the data processing units, wherein the data processing units operate independently of each other.

It should be noted that, in particular when the sensor is designed as an RFID receiver, that detects the presence of an RFID transmitter, process data are stored in the memory of the RFID transmitter, and may contain information such as identification numbers, information on the type of RFID transmitter or transmitter state or check sums and the like. Thus, process data may also include diagnostic data of the sensor. Request data are in particular requests or commands by the safety control device.

The data processing units compare the results of their verifying with each other and report an error to the safety control device if there is no match.

Feedback and response data from the first data processing unit are simultaneously returned to the safety control device and the second data processing unit, wherein the safety control device and the second data processing unit simultaneously carry out a verification of the response data. The second data processing unit and the safety control device compare the results of their verifying with each other and, if they do not match, judge the response data as erroneous. Thus, the second data processing unit can carry out a plausibility check of the data at the same time as the safety control device and, in the event of a deviation or inconsistency, report an exception or an error with considerable time savings.

For example, the communication of the sensor, i.e. in particular the data processing units with the safety control device, may occur in compliance with the IO-Link Safety Standards, the AS-i bus standard or the CANopen safety standard.

As previously stated, the two data processing units read the data independently of each other or independently output the data to the two data processing units. This occurs according to the invention on two channels and independently. It should be noted that the inputting, the outputting and the processing of the data are independent of each other and the data processing units are insofar independent of each other. Normally, the data processing units also differ with regard to their specific hardware implementation; however, the data processing units may, for example, have a common voltage supply and nevertheless be independent of one another within the meaning of the present invention.

The advantages are further achieved by the connection of the safety control device with the data processing units via a single, common serial bus.

In one embodiment, in the sensor unit according to the invention, the safety control device is connected to the data processing units via a common serial bus. The second data processing unit and the safety control device are designed to simultaneously check the data consistency and the correct processing of the data supplied to them by the first data processing unit. This allows fast processing and verification of the data.

In one embodiment, the bus is designed for bidirectional data transmission, and further, the safety control device and the data processing units can be designed to communicate with one another and thereby use the IO-Link safety standard, the AS-i bus standard or the CANopen safety standard.

In a further embodiment, the sensor is designed as an RFID receiver, which reacts to the approach of an RFID transmitter.

In general, the advantages of the methods and sensors previously described in various embodiments are, in particular, that time is saved by the simultaneous processing of the request data or the response data and the entire safety system therefore has very fast reaction times, resulting in an overall positive effect on the safety-related design of higher-level systems such as manufacturing facilities. Such a sensor unit can therefore be used advantageously in a system for securing hazardous areas of manufacturing facilities.

Furthermore, with methods and sensors implemented according to the invention, safety-relevant data may be communicated in a safety-relevant device in compliance with the requirements of IEC61508 for SIL3 via the IO-Link Safety Standard or other safety communication protocols such as AS-i bus or CANopen safety.

### BRIEF DESCRIPTION OF THE DRAWINGS

FIG. 1 shows a sensor unit with a safety control device.

### DETAILED DESCRIPTION OF THE INVENTION

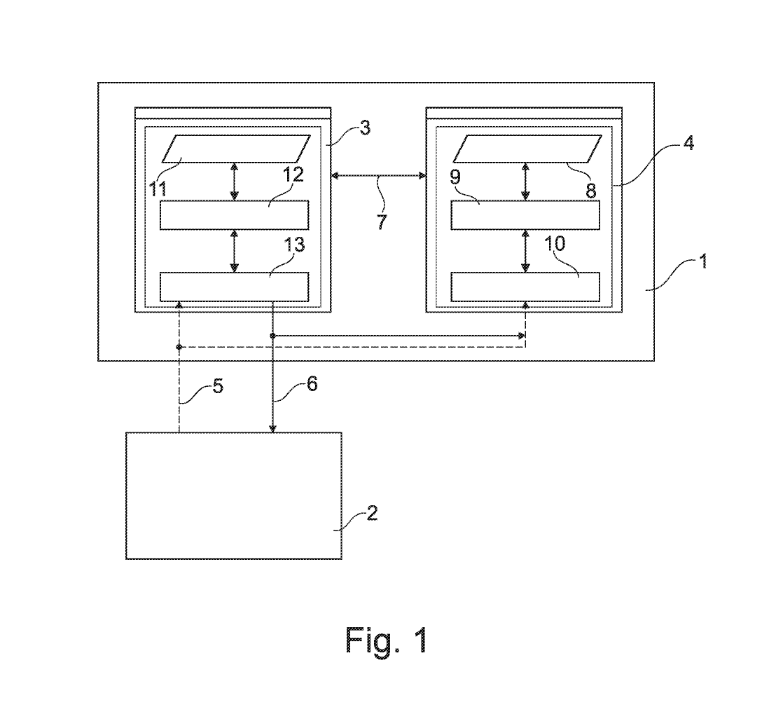

FIG. 1 shows a block diagram of a sensor unit according to the invention with a sensor 1 and a safety control device 2. The sensor 1 has a first and a second data processing unit 3, 4, which are independent of each other. These two data processing units 3, 4 differ in the specific design of their hardware, but are functionally identical in terms of their operation and mode of action. The data processing units 3, 4 are connected to the safety control device 2 via a single bus, which is shown only schematically. Request data or control instructions or commands are sent from the safety control device to the processing units 3, 4 in the transmission direction 5 via the common bus, and response data such as sensor measured values, sensor identification numbers and the like are transmitted in the transmission direction 6.

The first data processing unit 4 has a first processing unit 8, which checks the plausibility and processes data, that is to say the request data or the response data. The verification or plausibility check of the data can be carried out by means of so-called check sums via known verification methods, such as, for example, the CRC method.

Upstream of this first processing unit 8 is a first data transfer unit 9, which packs or unpacks the data according to a standard, in particular according to the IO-Link Safety Standard. Before the first data transfer unit 9, a first transmitting and receiving unit 10 is arranged, which encodes or decodes the data packets.

Accordingly, in the same arrangement, the second data processing unit 3 has a second processing unit 11, a second data transfer unit 12 and a second sending and receiving unit 13. Both data processing units 3 and 4 are connected to one another via a message line, through which exception messages, such as a different verification results are transmitted.

It should be noted that in the event that the sensor 1 is designed as an RFID receiver, the RFID transmitter unit is not shown in FIG. 1.

It should be noted that the method described here, the system described here and the sensor described here have always been described in connection with safety doors for machines and production facilities. It goes without saying that the solutions according to the invention for the method, system and sensor can also be used in other fields in which an approach of one component to another must be detected. For example, the invention could be applied to drawers (whether open or closed) or robotic arms (proximity verifications, or tool recognition).

1. A method for the serial transmission sensor data, comprising:
transmitting sensor data from a sensor to a safety control device;
simultaneously supplying the same sensor data to first and second data processing unit, the first and second data processing units operating independently of each other; and
simultaneously performing a verification of the supplied sensor data with the first and second data processing units after receiving the sensor data.

2. The method of claim 1, wherein the supplied sensor data is either request data of the safety control device or process data of the sensor.

3. The method of claim 1, further comprising comparing with the first and second data processing units results of the first and second data processing units respective verifications to one another and reporting an error to the safety control device if the respective verifications do not match.

4. The method of claim 3, further comprising checking data consistency of the received data during the verification.

5. The method of claim 1, wherein response data are simultaneously returned from the first data processing unit to the safety control device and to the second data processing unit and the safety control device and the second data processing unit simultaneously carry out a verification of the response data.

6. The method of claim 5, wherein the second data processing unit and the safety control device compare the results of the verification with each other and assess the response data as faulty when there is no match.

7. The method of claim 6, wherein the verification covers both the data consistency and the processing of the data.

8. The method of claim 1, wherein communication of the first and second data processing units with the safety control device occurs in compliance with an IO-Link Safety standards, an AS-i bus standards, a CANopen safety standard or a Profisafe standard for Profibus/Profinet.

9. A sensor unit, comprising:
a sensor, a safety control device and first and second data processing units associated with the sensor, the safety control device connected to the first and second data processing units via a common serial bus and the data processing units are independent of one another and configured to simultaneously carry out processing of supplied data from the sensor.

10. The sensor unit of claim 9, further comprising a bus configured for bidirectional data transmission.

11. The sensor unit of claim 9, wherein the safety control device is connected to the first and second data processing units via a common serial bus and the second data processing unit and the safety control device are configured to simultaneously check a data consistency and a correct processing of data supplied to them by the first data processing unit.

12. The sensor unit of claim 9, wherein the safety control device and the first and second data processing units are designed to communicate with each other using an IO-Link Safety Standard, an AS-i Bus Standard, a CANopen Safety Standard or a Profisafe Standard for Profibus/Profinet.

13. The sensor unit of claim 9, wherein the sensor comprises an RFID receiver that responds to an approach of an RFID transmitter.

14. The sensor unit of claim 13, wherein process data of the sensor are stored in the RFID transmitter, and the RFID receiver is adapted to read and to process the stored data in its data processing units.

15. A system for securing hazardous areas of manufacturing facilities, comprising:
a sensor unit, the sensor unit comprising:
a sensor, a safety control device and first and second data processing units associated with the sensor, the safety control device connected to the first and second data processing units via a common serial bus and the data processing units are independent of one another and configured to simultaneously carry out processing of supplied data from the sensor.

16. The system of claim 15, further comprising a bus configured for bidirectional data transmission.

17. The system of claim 15, wherein the safety control device is connected to the first and second data processing units via a common serial bus and the second data processing unit and the safety control device are configured to simultaneously check a data consistency and a correct processing of data supplied to them by the first data processing unit.

18. The system of claim 15, wherein the safety control device and the first and second data processing units are designed to communicate with each other using an IO-Link Safety Standard, an AS-i Bus Standard, a CANopen Safety Standard or a Profisafe Standard for Profibus/Profinet.

19. The system of claim 15, wherein the sensor comprises an RFID receiver that responds to an approach of an RFID transmitter.

20. The system of claim 19, wherein process data of the sensor are stored in the RFID transmitter, and the RFID receiver is adapted to read and to process the stored data in its data processing units.
